(19) United States
(12) Patent Application Publication
(10) Pub. No.: US 2004/0120402 A1
(43) Pub. Date: Jun. 24, 2004

(54) Motion estimation apparatus for image data compression

(76) Inventors: Seong-Mo Park, Daejeon-city (KR); Seung-Chul Kim, Daejeon-city (KR); Mi-Young Lee, Daejeon-city (KR); Han-Jin Cho, Daejeon-city (KR); Jong-Dae Kim, Daejeon-city (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/623,611

(22) Filed: Jul. 22, 2003

(30) Foreign Application Priority Data
Sep. 9, 2002 (KR) 2002-54321

(51) Int. Cl. H04N 7/12

(52) U.S. Cl. 375/240.16; 348/699; 375/240.12

(57) ABSTRACT

A motion estimation apparatus is provided. The motion estimation apparatus includes a demultiplexer which receives a selection flag from a user and current image data, and selectively outputs the current image data using one output terminal selected from a plurality of output terminals by the selection flag, a motion estimator which performs a motion estimation operation on the current image data using one motion estimation algorithm selected from a plurality of motion estimation algorithms depending on the output of the demultiplexer, and outputs a motion vector, and a multiplexer which receives the selection flag and outputs the motion vector in response to the selection flag.

### BACKGROUND OF THE INVENTION

1. Field of the Invention

The present invention relates to a motion estimation apparatus for image data compression, and more particularly, to an apparatus for motion estimation, which can perform operations according to a predetermined algorithm selected from among various algorithms.

2. Description of the Related Art

Motion estimation is one of the core techniques for processing image data. As presented in common standards for compressing and encoding moving images, such as Recommendation H.261 and the Moving Pictures Expert Group (MPEG), motion estimation plays the most important role in realizing high compression of moving image data by removing redundancy in temporal and spatial information of the moving image data.

FIG. 1 is a block diagram of a conventional apparatus for motion estimation adopting a combination of a one-pixel greedy search (OPGS) algorithm and a hierarchical search block matching (HSBM) algorithm. Referring to FIG. 1, a conventional apparatus 10 for motion estimation includes a candidate vector predictor 11, an algorithm selector 13, a motion estimator 15, a memory 17, and a half-pixel-based motion estimator 19.

The candidate vector predictor 11 receives image data and predicts a candidate vector for a macroblock to be estimated. The candidate vector predictor 11 finally selects a motion vector, which is most appropriate for the macroblock, among a zero motion vector, a previous motion vector, and motion vectors for neighboring blocks. The algorithm selector 13 compares the sum of absolute difference (SAD) of the candidate vector predicted by the candidate vector predictor 11 with a predetermined critical value so as to select an algorithm for motion estimation. In other words, the algorithm selector 13 selects either an OPGS algorithm or an HSBM algorithm. The motion estimator 15 performs integer-pixel-based motion estimation on the input image data and then outputs a motion vector. In the integer-pixel-based motion estimation, the algorithm selected by the algorithm selector 13 between the OPGS algorithm and the HSBM algorithm is used. The memory 17 stores the motion vector output from the motion estimator 15 and applies to the motion vector to the candidate vector predictor 11. The half-pixel-based motion estimator 19 estimates the half-pixel-based motion of the macroblock and a sub-block in the input image data, according to the result of performing the integer-pixel-based motion estimation on the input data.

The conventional apparatus 10 for motion estimation predicts a motion vector. If the predicted motion vector is within a range of critical values, the conventional apparatus 10 for motion estimation performs motion estimation on a small number of search regions following an OPGS algorithm. On the other hand, if the predicted motion vector is not included in the range of critical values, the conventional apparatus 10 for motion estimation performs motion estimation on all search regions. Accordingly, it is possible to enhance the efficiency of motion estimation. However, since the conventional apparatus 10 for motion estimation has different memories provided for their respective algorithms, the amount of data being calculated in motion estimation is large, and thus it is not easy to implement the conventional apparatus 10 for motion estimation in a real-time image encoder. In addition, the conventional apparatus 10 for motion estimation must include an additional memory for storing motion vectors, and thus there is a limit in reducing the area and power consumption of the apparatus. Moreover, since the conventional apparatus 10 for motion estimation adopts a fixed algorithm, it may perform processes which are unnecessary for certain kinds of images and certain applications.

### SUMMARY OF THE INVENTION

The present invention provides a motion estimation apparatus, which includes various algorithms and performs motion estimation using a most appropriate algorithm selected by the user from among the various algorithms.

According to an aspect of the present invention, there is provided a motion estimation apparatus. The motion estimation apparatus includes a demultiplexer which receives a selection flag from a user and current image data, and selectively outputs the current image data using one output terminal selected from a plurality of output terminals by the selection flag, a motion estimator which performs a motion estimation operation on the current image data using one motion estimation algorithm selected from a plurality of motion estimation algorithms depending on the output of the demultiplexer, and outputs a motion vector, and a multiplexer which receives the selection flag and outputs the motion vector in response to the selection flag.

Preferably, the plurality of motion estimation algorithms performed in the motion estimator includes a full search algorithm, a two-step hierarchical algorithm, a three-step hierarchical algorithm, and a four-step hierarchical algorithm.

Preferably, the motion estimator includes a first memory which stores the current image data and then outputs image data stored in an address input, a second memory which stores previous image data and then outputs previous image data stored in an address input, a data processor which receives the image data from the first and second memories and performs a motion estimation on the input image data, and an address generation unit which provides an address command to each of the first and second memories.

Preferably, the address generation unit determines an address to be output based on the selection flag input from the user.

Preferably, the address generation unit includes a controller, a first selector which selectively outputs the selection flag input in response to a control signal generated by the controller using one of a plurality of output terminals, an address generator which receives the selection flag from the first selector and then generates an address in response to the selection flag, and a second selector which outputs the address generated by the address generator in response to a control signal generated from the controller.

Preferably, the data processor has a plurality of unit data processors connected in parallel.

Preferably, each of the plurality of unit data processors includes a first register which stores and outputs the current image data, a second register which stores and outputs row data of the previous image data, a third register which stores and outputs column data of the previous image data, a first multiplexer which selectively outputs the row data input from the second register or the column data input from the third register, a substractor which calculates differences between the current image data input from the first register and the row data or column data of the previous image data input from the first multiplexer and outputs a result of the subtraction, and an adder which adds an output of the substractor to previous values fed back to the adder and outputs an absolute value of a result of the adding.

Preferably, the motion estimation apparatus further includes a fourth register and a fifth register which stores the outputs of the adder, a second multiplexer which selectively feeds the outputs of the fourth register or the outputs of the fifth register back to the adder, a third multiplexer which selectively outputs the outputs of the fourth register or the outputs of the fifth register, and a sixth register which stores and outputs the outputs of the third multiplexer.

### BRIEF DESCRIPTION OF THE DRAWINGS

The above and other aspects and advantages of the present invention will become more apparent by describing in detail a preferred embodiment thereof with reference to the attached drawings in which:

FIG. 1 is a block diagram of a conventional apparatus for motion estimation;

FIG. 2 is a block diagram of an apparatus for motion estimation according to a preferred embodiment of the present invention;

FIG. 3 is a block diagram of a motion estimator shown in FIG. 2 according to a preferred embodiment of the present invention;

FIG. 4 is a block diagram of an address generator shown in FIG. 3 according to a preferred embodiment of the present invention;

FIG. 5A is a block diagram of a data processor shown in FIG. 3 according to a preferred embodiment of the present invention; and

FIG. 5B is a block diagram of a unit data processor shown in FIG. 5A according to a preferred embodiment of the present invention.

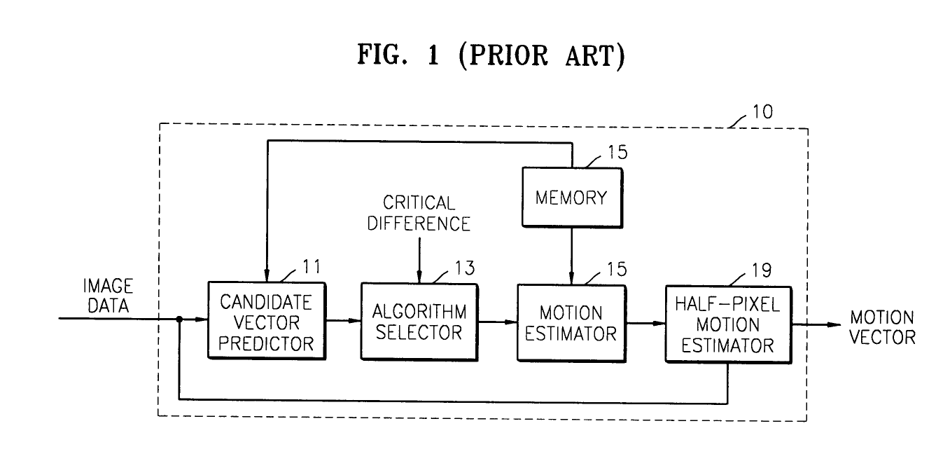

### DETAILED DESCRIPTION OF THE INVENTION

Hereinafter, the present invention will now be described more fully with reference to the accompanying drawings, in which a preferred embodiment of the present invention is shown. This invention may, however, be embodied in many different forms and should not be construed as being limited to the embodiment set forth herein.

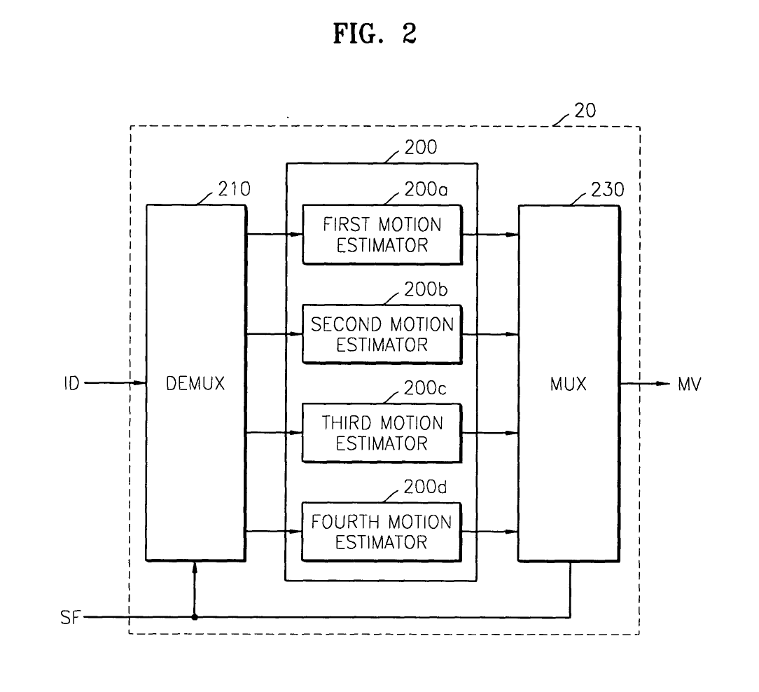

FIG. 2 is a block diagram of an apparatus for motion estimation according to a preferred embodiment of the present invention. Referring to FIG. 2, an apparatus 20 for motion estimation includes a demultiplexer 210, a motion estimator 220, and a multiplexer 230.

The demultiplexer 210 receives current image data (ID) through an input terminal and receives a selection flag (SF) from a user via another input terminal. The demultiplexer 210 includes four output terminals and outputs the current image data (ID) via one of the four output terminals selected based on the selection flag (SF). The selection flag (SF) is a signal determined by the user. The user determines a desired motion estimation algorithm in consideration of a desired amount of time taken to perform motion estimation and the quality of compressed images. The user also determines an output terminal of the demultiplexer 210 to be activated so that the desired motion estimation algorithm can be performed.

All the output terminals of the demultiplexer 210 are connected to the motion estimator 220 and are supposed to perform different motion estimation operations for different algorithms. In other words, the motion estimator 220 includes four motion estimators, i.e., first through fourth motion estimators 220a through 220d. The first, second, third, and fourth motion estimators 220a, 220b, 220c, and 220d are connected to first, second, third, and fourth output terminals of the demultiplexer 210, respectively. The four motion estimators 220a through 220d perform different motion estimation operations following different motion estimation algorithms. For example, the first motion estimator 220a performs a motion estimation operation following a full search algorithm, the second motion estimator 220b performs a motion estimation operation following a two-step hierarchical search algorithm, the third motion estimator 220c performs a motion estimation operation following a three-step hierarchical search algorithm, and the fourth motion estimator 220d performs a motion estimation operation following a four-step hierarchical search algorithm.

The multiplexer 230 has four input terminals, which are respectively connected to the output terminals of the motion estimator 220, and receives the selection flag (SF) from the user via another input terminal. The multiplexer 230 selects a motion vector (MV), which is one of the outputs of the motion estimator 220, based on the selection flag (SF) and outputs the motion vector (MV) via an output terminal.

The full search algorithm adopted by the first motion estimator 220a is one kind of block matching algorithm and can provide the best search results, even though the amount of data being calculated in the full search algorithm is very large. Here, the block matching algorithm is a technique of estimating a motion between two temporally-neighboring frames by dividing a current frame into blocks having a fixed size and searching for a best match block for each of the blocks in a previous frame.

The two-step hierarchical search algorithm adopted by the second motion estimator 220b is a technique of extracting motion vectors from hierarchical images, from an upper level to a lower level in the hierarchy of the images. In other words, a more precise motion vector for a middle level in the hierarchy of the images is determined using a motion vector extracted from the uppermost level as an initial value, and then a motion vector for a lower level is determined using the motion vector for the middle level. The two-step hierarchical search algorithm requires less computations for its search region size. However, it is not easy to control the two-step hierarchical search algorithm. Specifically, reference block data in a current image, the motion vector of which is desired to be obtained, and search block data in a previous image, corresponding to the reference block data, are stored in a reference block memory and a search block memory, respectively. Next, only odd-numbered pixels are sampled, and motion search is performed on every two units of the sampled pixels (or two-integer-pixel-based motion search is performed on the sampled pixels), thus obtaining a two-integer-pixel-based motion vector (TMVx, TMVy). In the motion search, the reference block data and the search block data, which are each divided into four parts including two columns with a ratio of 2:1 and two rows with a ratio of 2:1, and a search range is [−7, +4]. Next, half-pixel-based motion search is performed using a reference position (2*TMVx+MVx, 2*TMVy+MVy) obtained from one-integer-pixel-based motion search, thus obtaining a half-pixel-based motion vector (HMVx, HMVy). A search range in the half-pixel-based motion search is [−0.5, +0.5].

In the three-step hierarchical search algorithm adopted by the third motion estimator 220c, a full search operation is performed on 8 pointers among 9 pointers for easy realization of the search algorithm into hardware. The three-step hierarchical search algorithm may have a different number of steps. For example, the three-step hierarchical search algorithm may be realized into four steps if a search range is [−15, +15], or five steps if a search range is [−31, +31]. In addition, when a search range is [−15, +15], a search operation is performed on 33 (9+8+8+8) pointers. When a search range is [−31, +31], a search operation is performed on 41 (9+8+8+8+8) pointers.

The four-step search hierarchical algorithm adopted by the fourth motion estimator 220d takes advantage of the centralization characteristics of motion vectors. For example, when a search range is [−7, 7], 9 points in a search block having a size of 5×5 are searched in a first step of the four-step hierarchical search algorithm, while 9 points in a search block having a size of 9×9 are searched in a first step of the three-step hierarchical search algorithm. In a second step, the center of the 5×5 search block is moved to a minimum BDM (Block Distortion Measurement) pointer. In third and fourth steps, the size of the search block varies depending on the location of the minimum BDM pointer. For example, if the minimum BDM pointer is found at the center of the search block, motion search is performed in a fourth step when the size of the search block is 3×3. If the minimum BDM pointer is found in any place other than the center of the search block, the size of the search block does not change during the second and third steps, and finally the size of the search block is reduced to a size of 3×3 in the fourth step.

The detailed description of the four-step hierarchical search algorithm is as follows. In the first step, 9 points are searched in a search block having a size of 5×5, which is located in the middle of a search region having a size of 15×15, in order to find a minimum BDM pointer. If the minimum BDM pointer has been found at the center of the search block, the algorithm directly moves on to the fourth step. If the minimum BDM pointer has not been found at the center of the search block, the algorithm moves on to the second step. In the second step, the size of the search block is maintained at a size of 5×5. However, a search method varies depending on the position of the minimum BDM pointer. In other words, if the minimum pointer is located in the corner of the search block, five points are additionally searched. If the minimum BDM pointer is located in the middle of the longitudinal or latitudinal axis of the search block, three points are additionally searched. Thereafter, the minimum BDM pointer is located at the center of the search block, the algorithm moves on to the next step. If the minimum BDM pointer is not located at the center of the search block, the algorithm moves on to the third step. In the third step, the search block still has a size of 5×5. If the minimum BDM pointer is located at the center of the search block, the algorithm moves on to the fourth step. In the fourth step, the size of the search block is reduced to a size of 5×5. Among the nine points, the BDM pointer is considered as a final motion vector.

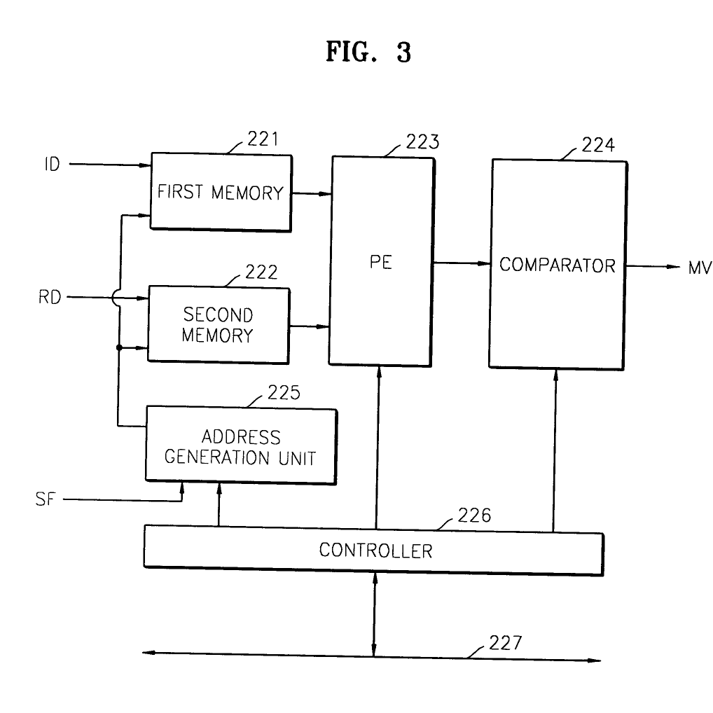

FIG. 3 is a block diagram of a motion estimator 200 shown in FIG. 2 according to a preferred embodiment of the present invention. Referring to FIG. 3, current image data (ID) and previous image data (RD) are stored in a first memory 221 and a second memory 222, respectively. The first and second memories 221 and 222 each output image data, which have been stored in an address determined by an address generation unit 225. The address generation unit 225 generates an address command in response to a control signal input from a controller 226 and a selection flag (SF) input from the user. The data output from the first and second memories 221 and 222 are input into a data processor 223. The data processor 223 performs a motion estimation operation on the current image data (ID) and the previous image data (RD), which are input in response to the control signal generated by the controller 226, and outputs a motion vector (MV). The motion vector (MV) is output via a comparator 224. The controller 226 receives and transmits signals from and to other elements using a bus system 227.

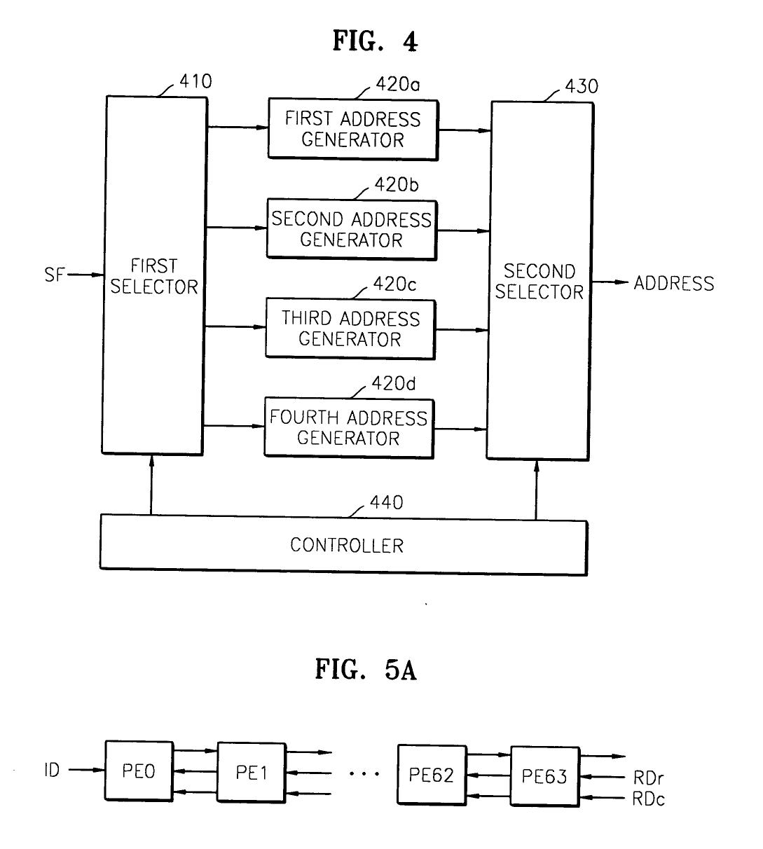

FIG. 4 is a block diagram of the address generation unit 225 shown in FIG. 3 according to a preferred embodiment of the present invention. Referring to FIG. 4, an address generator includes a first selector 410, a plurality of address generators 420a, 420b, 420c, and 420d, and a second selector 430, and a controller 440.

The first selector 410 receives a selection flag (SF) from the user via an input terminal and receives a control signal from the controller 440. The first selector 410 includes four output terminals and outputs the selection flag (SF) using one selected from the four output terminals by a control signal input from the controller 440.

The plurality of address generators 420a, 420b, 420c, and 420d are connected to the four output terminals, respectively, of the first selector 410, and the four output terminals generate different addresses. In other words, the first, second, third, and fourth address generators 420a, 420b, 420c, and 420d are connected to first, second, third, and fourth output terminals of the first selector 410, respectively. The first, second, third, and fourth address generators 420a, 420b, 420c, and 420d output different addresses corresponding to their respective motion estimation algorithms.

The second selector 430 includes four input terminals, which are respectively connected to the output terminals of the first through fourth address generators 420a, 420b, 420c, and 420d, and receives a control signal from the controller 440 via an additional input terminal. Then, the second selector 430 outputs an address input via one of the four input terminals via an output terminal.

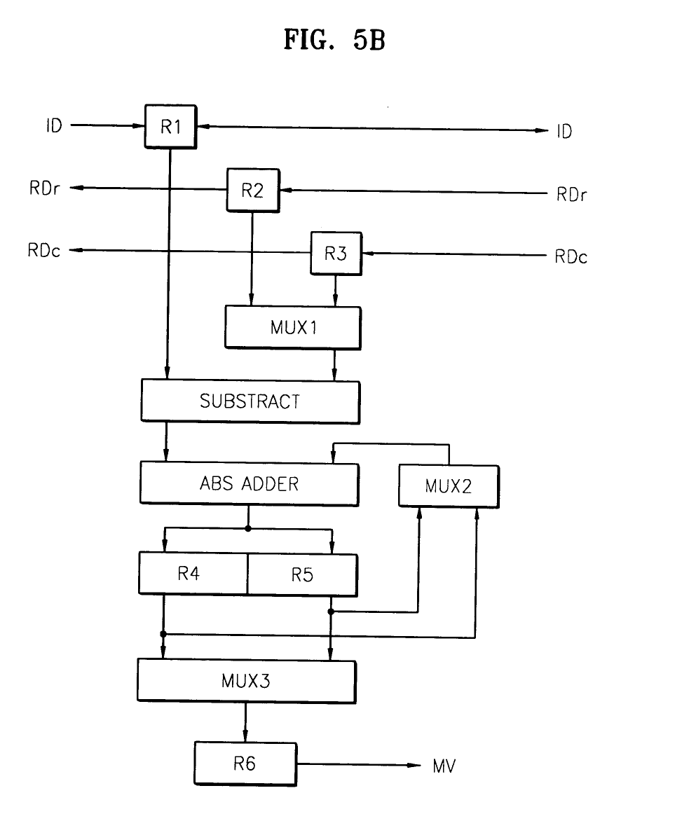

FIG. 5A is a block diagram of the data processor 223 shown in FIG. 3 according to a preferred embodiment of the present invention, and FIG. 5B is a block diagram of an example of a unit data processor shown in FIG. 5A according to a preferred embodiment of the present invention.

Referring to FIG. 5A, a data processor includes a plurality of unit data processors, for example, 64 unit data processors PE0, PE1, . . . , PE63, which are arranged in parallel. A first unit data processor PE0, which is located in the far left, receives current image data (ID) and receives previous image data (RD) from a second unit data processor PE1 at the same time. The first unit data processor transmits the input current image data (ID) to the second unit data processor PE1. A sixty fourth unit data processor PE63, which is located in the far right, receives the previous image data (RD) and receives the current image data (ID) from a sixty third unit data processor PE62 at the same time. The sixty fourth unit data processor PE63 transmits the previous image data (RD) to the sixty third unit data processor PE62. Each of the unit data processors PE0 through PE63 processes the current image data (ID) and the previous image data (RD) so as to output a motion vector.

Referring to FIG. 5B, each of the unit data processors PE0 through PE63 includes a first register R1, which stores and outputs the current data (ID), and second and third registers R2 and R3, which store and output the previous image data (RD). The previous image data (RD) are divided into row data (RDr) and column data (RDc), which are input into the second register R2 and the third register R3, respectively. In other words, the row data (RDr) are stored in the second register R2 and output from the second register R2, and the column data (RDc) are stored in the third register R3 and output from the third register R3. The row data (RDr) output from the second register R2 and the column data (RDc) output from the third register R3 are input into a first multiplexer MUX1. The first multiplexer MUX1 selectively outputs the row data (RDr) or the column data (RDc). The outputs of the first multiplexer MUX1 are input into a substractor (SUBSTRACT) together with the current image data (ID). The substractor (SUBSTRACT) calculates the differences between the current image data (ID) and the previous image data (RDr or RDc) and outputs the results of the subtraction. The outputs of the substractor (SUBSTRACT) are input into an adder (ABS ADDER). Previous outputs of the adder (ABS ADDER) are fed back to the adder (ABS ADDER). The adder (ABS ADDER) adds the previous outputs to the outputs of the substractor (SUBSTRACT), stores the results of the adding in fourth and fifth registers R4 and R5, and outputs the results of the adding. The outputs of the fourth register R4 are input into a second multiplexer MUX2 and a third multiplexer MUX3. Likewise, the outputs of the fifth register R5 are input into the second and third multiplexers MUX2 and MUX3. The second multiplexer MUX2 selects either the outputs of the fourth register R4 or the outputs of the fifth register R5 and outputs the selected values to the adder (ABS ADDER). The third multiplexer MUX3 selects either the outputs of the fourth register R4 or the outputs of the fifth register R5, stores the selected values in a sixth register R6, and outputs the stored values as a motion vector (MV).

As described above, the apparatus for motion estimation according to the present invention is capable of selecting any of a plurality of motion estimation algorithms and then performing a motion estimation operation following the selected algorithm. Thus, there is no need to perform operations, which may not be necessary for certain kinds of images or certain kinds of applications, and the efficiency of motion estimation operations can be enhanced. In addition, the apparatus for motion estimation according to the present invention does not require an inner memory for storing motion vectors, and thus it is possible to manufacture an apparatus for motion estimation having a reduced size and low power consumption.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A motion estimation apparatus comprising:
a demultiplexer which receives a selection flag from a user and current image data, and selectively outputs the current image data using one output terminal selected from a plurality of output terminals by the selection flag;
a motion estimator which performs a motion estimation operation on the current image data using one motion estimation algorithm selected from a plurality of motion estimation algorithms depending on the output of the demultiplexer, and outputs a motion vector; and
a multiplexer which receives the selection flag and outputs the motion vector in response to the selection flag.

2. The apparatus of claim 1, wherein the plurality of motion estimation algorithms performed in the motion estimator includes a full search algorithm, a two-step hierarchical algorithm, a three-step hierarchical algorithm, and a four-step hierarchical algorithm.

3. The apparatus of claim 1, wherein the motion estimator comprises:
a first memory which stores the current image data and then outputs image data stored in an address input;
a second memory which stores previous image data and then outputs previous image data stored in an address input;
a data processor which receives the image data from the first and second memories and performs a motion estimation on the input image data; and
an address generation unit which provides an address command to each of the first and second memories.

4. The apparatus of claim 3, wherein the address generation unit determines an address to be output based on the selection flag input from the user.

5. The apparatus of claim 3, wherein the address generation unit comprises:
a controller;
a first selector which selectively outputs the selection flag input in response to a control signal generated by the controller using one of a plurality of output terminals;
an address generator which receives the selection flag from the first selector and then generates an address in response to the selection flag; and
a second selector which outputs the address generated by the address generator in response to a control signal generated from the controller.

6. The apparatus of claim 3, wherein the data processor has a plurality of unit data processors connected in parallel.

7. The apparatus of claim 6, wherein each of the plurality of unit data processors comprises:
a first register which stores and outputs the current image data;
a second register which stores and outputs row data of the previous image data;
a third register which stores and outputs column data of the previous image data;
a first multiplexer which selectively outputs the row data input from the second register or the column data input from the third register;
a substractor which calculates differences between the current image data input from the first register and the row data or column data of the previous image data input from the first multiplexer and outputs a result of the subtraction; and
an adder which adds an output of the substractor to previous values fed back to the adder and outputs an absolute value of a result of the adding.

8. The apparatus of claim 7 further comprising:
a fourth register and a fifth register which stores the outputs of the adder;
a second multiplexer which selectively feeds the outputs of the fourth register or the outputs of the fifth register back to the adder;
a third multiplexer which selectively outputs the outputs of the fourth register or the outputs of the fifth register; and
a sixth register which stores and outputs the outputs of the third multiplexer.
